(19) United States
(12) Patent Application Publication
(10) Pub. No.: US 2001/0022339 A1
(43) Pub. Date: Sep. 20, 2001

(54) Probe signal outputting apparatus

(76) Inventors: Yoshiki Yanagisawa, Tokyo (JP); Nobukazu Banjo, Tokyo (JP); Jun Kikuchi, Tokyo (JP); Sanjay Gupta, Tokyo (JP); Mitsuru Shinagawa, Isehara-shi (JP); Chisato Hashimoto, Sagamihara-shi (JP); Tadao Nagatsuma, Sagamihara-shi (JP); Hakaru Kyuragi, Tokyo (JP)

Correspondence Address: Robert E. Krebs, Esq., BURNS, DOANE, SWECKER & MATHIS, L.L.P., P.O. Box 1404, Alexandria, VA, 22313-1404, US

(21) Appl. No.: 09/738,764

(22) Filed: Dec. 18, 2000

(30) Foreign Application Priority Data
Dec. 27, 1999 (JP) 11-371914

(51) Int. Cl. H01J 40/14

(52) U.S. Cl. 250/214 R

(57) ABSTRACT

Disclosed is a probe signal outputting apparatus which comprises an electrooptic probe for receiving an optical output from a light source and outputting a first optical signal and a second optical signal which are polarized in accordance with a voltage of a to-be-probed signal from an object to be measured; a first photoelectric converting element and a second photoelectric converting element, connected in series between a first bias power supply and a second bias power supply, for respectively receiving the first optical signal and the second optical signal and converting the first and second optical signals to electric signals; an output circuit for outputting an electric signal acquired at a connection node between the first photoelectric converting element and the second photoelectric converting element to a measuring circuit; an adder for adding voltage values equivalent to currents respectively flowing in the first photoelectric converting element and the second photoelectric converting element; and a drive-current control circuit for causing a current drive circuit to supply a drive current according to a change in an added output from the adder to the light source.

### BACKGROUND OF THE INVENTION

1. Field of the Invention

The present invention relates to a probe signal outputting apparatus which acquires, as a probe signal, an electric signal according to a to-be-probed signal, from an optical signal containing a polarization component according to the voltage of the to-be-probed signal and supplies the probe signal to a measuring unit.

This application is based on Japanese Patent Application No. Hei 11-371914 filed in Japan, the content of which is incorporated herein by reference.

2. Description of the Related Art

One conventional probe signal outputting apparatus comprises an electrooptic probe incorporating an optical system for coupling an electrooptic crystal whose polarization plane is changed by an electric field to a portion where an internal signal of a target object to be measured, such as an IC, (hereinafter called “to-be-probed signal”) appears, reproduces the to-be-probed signal according to the polarization state of reflected light from this electrooptic crystal and acquires an optical signal having a polarization state corresponding to the to-be-probed signal, and a light receiving circuit for receiving this optical signal and acquiring an electric signal according to the polarization state of the optical signal.

This probe signal outputting apparatus has the following advantages over a conventional measuring system using an electric probe.

1) Due to no ground line needed at the time of measuring a signal, measurement is easier.

2) As a metal pin at the distal end of the electrooptic probe is electrically insulated from circuits on an oscilloscope side, waveform observation is possible without nearly disturbing the status of a to-be-probed signal.

3) The use of an optical pulse ensures measurement in a wide band in the order of up to gigahertz.

An example of the structure of an electrooptic probe which is used in this probe signal outputting apparatus will be described with reference to FIG. 2. In this diagram, a metal pin 1A which contacts a portion where a to-be-probed signal appears is fitted in the center of a probe head 1 made of an insulator. An electrooptic element (electrooptic crystal) 2 whose polarization plane is changed by an electric field has a reflection film 2A provided on that end face which is located on the metal pin side. The reflection film 2A is in contact with the metal pin 1A.

Numeral “4” denotes a ½ wavelength plate and numeral “5” denotes a ¼ wavelength plate. Numerals “6” and “8” are polarization beam splitters. Numeral “7” denotes a Faraday element. Numeral “9” denotes a laser diode which emits a laser beam in accordance with a pulse signal (control signal) output from the main body of a measuring unit (not shown), such as an EOS (ElectroOptic Sampling) oscilloscope. Numeral “10” denotes a collimator lens which converts the laser beam from the laser diode 9 to parallel beam. The electrooptic element 2, the ½ wavelength plate 4, the ¼ wavelength plate 5, the polarization beam splitters 6 and 8 and the Faraday element 7 are arranged on the optical path of a parallel laser beam L.

Numerals “11” and “13” denote converging lenses which respectively converge laser beams split by the polarization beam splitters 6 and 8. Numerals “12” and “14” denote photodiodes as photoelectric converting elements, which convert the laser beams converged by the conversing lenses 11 and 13 to electric signals and send the signals to the main body of the measuring unit. The photodiodes 12 and 14 constitute a light receiving circuit to be discussed below.

Numeral “15” is a probe body serving as an electrooptic probe. Numeral “17” denotes an isolator which comprises the ¼ wavelength plate 5, the two polarization beam splitters 6 and 8 and the Faraday element 7. The isolator 17 passes light emitted from the laser diode 9 and separates light which is reflected at the reflection film 2A.

An example of the structure of the conventional light receiving circuit which is used in a probe signal outputting apparatus will now be described with reference to FIG. 3. In this diagram, numeral “100” is a bias power supply, numerals “12” and “14” are photodiodes, numerals “102” and “105” are resistors, numerals “103” and “106” are amplifiers, numeral “107” is a current monitor, numeral “108” is an A/D converter, numeral “109” is a differential amplifier which comprises resistors 109A to 109D and an operational amplifier 109E, numeral “110” is a resistor and numeral “111” is an A/D converter.

In this light receiving circuit, the amplifiers 103 and 106 respectively amplify currents, which are generated by the photodiodes 12 and 14 and are biased by the bias power supply 100, and the differential amplifier 109 amplifies the difference between the outputs of the amplifiers 103 and 106, thus yielding a probe signal. The output value of the differential amplifier 109 is subjected to A/D conversion in the A/D converter 111. The currents generated by the photodiodes 12 and 14 are monitored by the current monitor 107 and the current values are subjected to A/D conversion in the A/D converter 108.

The operation of this conventional apparatus will be discussed below. The laser diode 9 shown in FIG. 2 emits a pulsed laser beam having a sampling period when driven by a pulse signal (control signal). This laser beam is converted by the collimator lens 10 to parallel light which travels straight through the polarization beam splitter 8, the Faraday element 7 and the polarization beam splitter 6, further passes through the ¼ wavelength plate 5 and the ½ wavelength plate 4 and enters the electrooptic element 2.

The incident laser beam is reflected by the reflection film 2A formed at the end face of the electrooptic element 2 that is located on the metal pin side. When the metal pin 1A is put in contact with a probing point, an electric field according to the voltage that is applied to the metal pin 1A propagates to the electrooptic element 2, causing the index of refraction of the electrooptic element 2 to change due to the Pockels effect. As the laser beam emitted from the laserdiode 9 propagates in the electrooptic element 2, the polarization state of the light changes, so that the laser beam reflected at the end face 2A of the electrooptic element 2 contains a polarized component according to the voltage of a to-be-probed signal.

The laser beam reflected at the end face 2A of the electrooptic element 2 passes through the ½ wavelength plate 4 and the ¼ wavelength plate 5 again, and a part of this laser beam (the polarized component according to the voltage of the to-be-probed signal) is separated by the polarization beam splitter 6 and is converged by the conversing lens 11 before entering the photodiode 12 that constitutes the light receiving circuit. The laser beam that has passed the polarization beam splitter 6 is separated by the polarization beam splitter 8 and is converged by the conversing lens 13. This converged light enters the photodiode 14 shown in FIG. 3 to be converted to an electric signal.

The operation of the light receiving circuit will now be discussed. When the index of refraction of the electrooptic element 2 changes due to a change in the voltage of the to-be-probed signal, the output of the photodiode 12 differs from the output of the photodiode 14. The light receiving circuit operates in such a way as to detect this output difference and output a probe signal according to the to-be-probed signal.

This will be described below specifically. When the photodiode 12 of the light receiving circuit receives the laser beam from the polarization beam splitter 6, the photodiode 12 produces the current according to the intensity of this laser beam. A voltage according to this current appears at one end of the resistor 102 and is amplified by the amplifier 103. The differential amplifier 109 sends a probe signal according to the difference between the outputs of the amplifiers 103 and 106 to the main body of the measuring unit.

According to the conventional light receiving circuit, as apparent from the above, signals detected by the photodiodes 12 and 14 are respectively amplified by the amplifiers 103 and 106 and the difference between both amplified signals is then acquired by the differential amplifier 109, thus allowing only a probe signal to be detected.

The current that is monitored by the current monitor 107 is subjected to A/D conversion by the A/D converter 108 and the value of the resultant signal is used together with the value of the probe signal acquired by conversion in the A/D converter 111 in verifying the operations of the photodiodes 12 and 14, calibration and so forth. Further, it is necessary to match the polarization plane of the incident laser beam with the crystal axis of the electrooptic element 2. The polarization plane is adjusted by turning the ½ wavelength plate 4 and the ¼ wavelength plate 5.

However, the conventional probe signal outputting apparatus has such shortcomings as that the sensitivity of detection of a to-be-probed signal changes due to a change in the amount of light which is caused by the temperature of the laser diode 9, i.e., due to a variation in the optical output, a loss in the optical system or the like, thereby causing a deterioration in the precision of probing the to-be-probed signal.

### SUMMARY OF THE INVENTION

Accordingly, it is an object of the present invention to provide a probe signal outputting apparatus which performs such control as to stabilize the optical output of a light source, such as a laser diode, thereby keeping the sensitivity of detection of a to-be-probed signal constant or automatically adjust that sensitivity, so that the precision of probing the to-be-probed signal can be improved.

According to this invention, the above object is achieved by a probe signal outputting apparatus which comprises an electrooptic probe for receiving an optical output from a light source and outputting a first optical signal and a second optical signal which are polarized in accordance with a voltage of a to-be-probed signal from an object to be measured; a first photoelectric converting element and a second photoelectric converting element, connected in series between a first bias power supply and a second bias power supply, for respectively receiving the first optical signal and the second optical signal and converting the first and second optical signals to electric signals; an output circuit for outputting an electric signal acquired at a connection node between the first photoelectric converting element and the second photoelectric converting element to a measuring circuit; an adder for adding voltage values equivalent to currents respectively flowing in the first photoelectric converting element and the second photoelectric converting element; and a drive-current control circuit for causing a current drive circuit to supply a drive current according to a change in an added output from the adder to the light source.

This structure can prevent the sensitivity of detection of a to-be-probed signal from being changed due to variations in the output of the light source, a loss in the optical system or the like, thereby keeping the sensitivity of detection constant, which leads to an improvement in the probing precision for a to-be-probed signal.

The drive current to be supplied to the light source from the current drive circuit may be made adjustable through an external manipulation. This structure can ensure arbitrary adjustment of the sensitivity of detection of a to-be-probed signal. Further, the current drive circuit may be subjected to feedback control based on a change in the added output from the adder in such a way as to make the added output constant. This structure can permit the sensitivity of detection of a to-be-probed signal to be automatically adjusted.

It is preferable that the operational amplifier should be connected to a reference voltage generator, which generates a reference voltage for controlling a feedback amount of a control input with respect to the current drive circuit, so that the light source can be driven by an arbitrary drive current according to a set reference voltage.

Further, a laser diode may be used as the light source, in which case the light incident to the electrooptic probe can have a sufficient intensity and the sensitivity of detection of a to-be-probed signal can be made sufficient high.

### BRIEF DESCRIPTION OF THE DRAWINGS

FIG. 1 is a block diagram showing a probe signal outputting apparatus according to one embodiment of this invention;

FIG. 2 is a structural diagram conceptually illustrating an electrooptic probe in an ordinary probe signal outputting apparatus; and

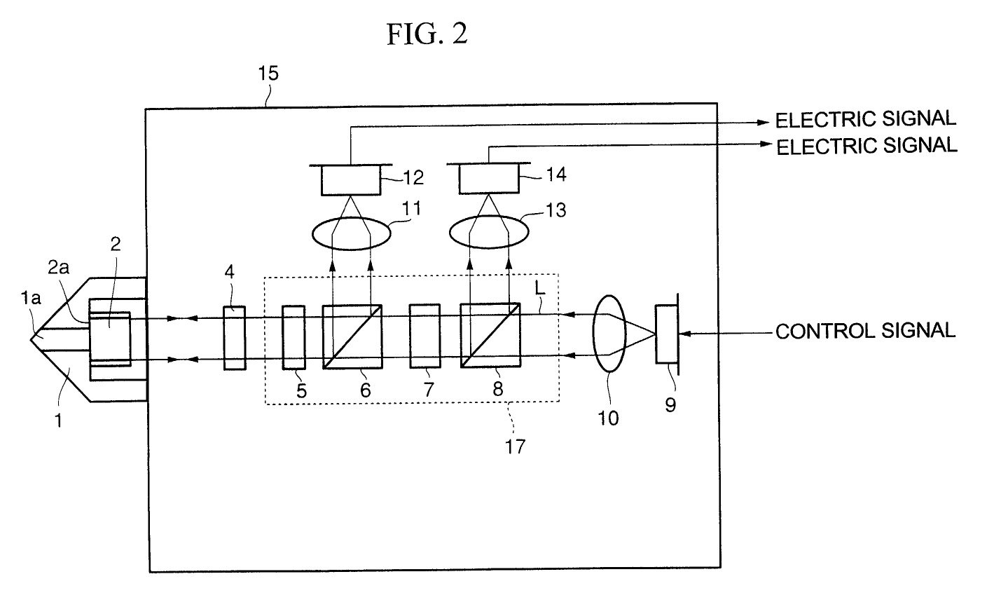

FIG. 3 is a block diagram showing a light receiving circuit in a probe signal outputting apparatus.

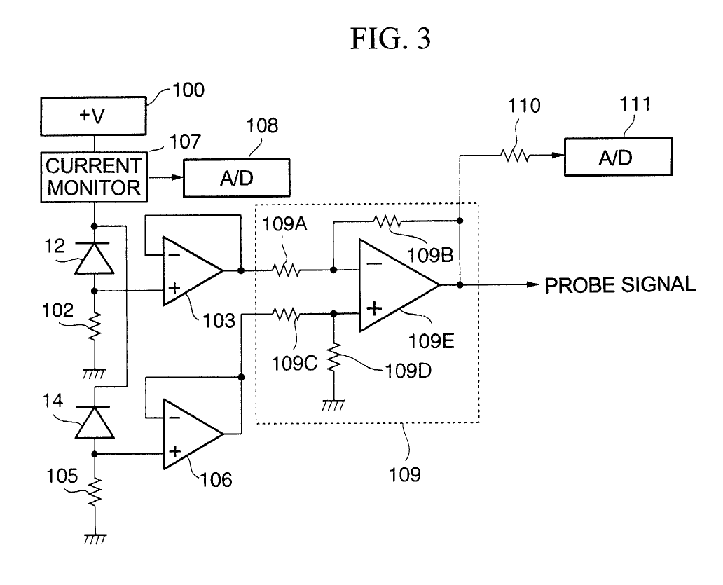

### DETAILED DESCRIPTION OF THE PREFERRED EMBODIMENT

An embodiment which will be discussed below in no way limits the present invention to the scope of the appended claims. Not all the features that will be described in the following description of the embodiment need to be combined in order to achieve the aforementioned object.

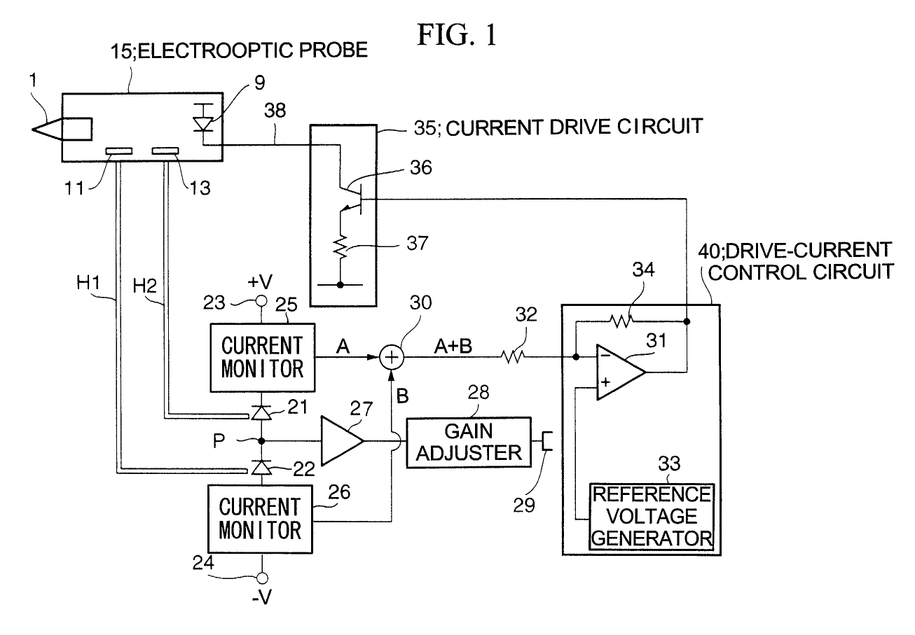

One embodiment of this invention will now be described with reference to the accompanying drawings. In FIG. 1 which is a block diagram showing a probe signal outputting apparatus according to this invention, numerals “21” and “22” are photodiodes serving as first and second photoelectric converting elements, which receive the laser beam from an electrooptic probe 15 via respective optical fiber cables H1 and H2. The photodiodes 21 and 22, which respectively correspond to the conventional photodiodes 12 and 14 discussed earlier, are connected in series in such a way that their current flowing directions match with each other. The series circuit of the photodiodes 21 and 22 is connected between a positive bias power supply 23 serving as a first bias power supply and a negative bias power supply 24 serving as a second bias power supply via current monitors 25 and 26 respectively. A signal output terminal 29 is connected to a connection node P between the photodiodes 21 and 22 via an amplifier 27 and a gain adjuster 28. A probe-signal input terminal of an oscilloscope or spectrum analyzer is to be connected to the signal output terminal 29. The amplifier 27 constitutes an output circuit which sends an electric signal, acquired at the connection node P between the photodiodes 21 and 22, to a measuring circuit, such as an oscilloscope.

The current monitors 25 and 26 respectively monitor and convert the currents that flow in the photodiodes 21 and 22 to voltages. Individual monitored values A and B are input to an adder 30 which performs the operation A+B. A change in the sum of the currents to be monitored corresponds to a change in the amount of light emission from a laser diode 9. The operation output of the adder 30 is input to the negative input terminal of an operational amplifier 31 via a resistor 32. An arbitrary reference voltage output from a reference voltage generator 33 is input to the positive input terminal of the operational amplifier 31. Therefore, the operational amplifier 31 outputs a control signal corresponding to the difference between the operation output of the adder 30 and the reference voltage from the reference voltage generator 33. A resistor 34 is connected between the output terminal and the negative input terminal of the operational amplifier 31. The resistor 34, together with the resistor 32, determines an amplification factor. The operational amplifier 31 and the reference voltage generator 33 constitute a drive-current control circuit 40.

A current drive circuit 35 is connected to the output side of the operational amplifier 31. The current drive circuit 35 is comprised of a current setting resistor 37 connected to the emitter of a transistor 36. The current drive circuit 35 supplies a drive current to the laser diode 9 serving as a light source via a coaxial cord 38 from the collector of the transistor 36 upon reception of the control signal (feedback signal) from the operational amplifier 31 at the base of the transistor 36, i.e., upon reception of the control signal according to changes in the monitored outputs of the current monitors 25 and 26. Note that the current drive circuit 35 outputs the drive current that causes the laser diode 9 to emit either pulse light or continuous light.

Although not illustrated, the amount of deterioration of the S/N ratio can be detected indirectly by inputting the monitored values (voltage values) of the currents flowing through the photodiodes 21 and 22 to a subtracter as needed and detecting the amount of deviation in the optical balance from the voltage difference obtained as the subtraction result. Therefore, the deviation in the optical balance can be suppressed by adjusting the polarization ratio of the optical signals received by the photodiodes 21 and 22 in such a way as to correct this deterioration amount or in the direction of suppressing the deterioration amount.

The operation of this apparatus will be discussed below. The photodiode 21 in the light receiving circuit receives the laser beam from the polarization beam splitter 6, which has the polarization state according to the to-be-probed signal, and generates a current according to the intensity of the laser beam. The photodiode 22 receives the laser beam from the polarization beam splitter 8 and generates a current according to the intensity of the laser beam. A signal representing the difference between the currents that are respectively produced in the photodiodes 21 and 22 appears at the connection node P and is output as a probe signal to the signal output terminal 29 via the amplifier 27 and the gain adjuster 28. This probe signal is supplied to the probe-signal input terminal of a measuring unit, such as an oscilloscope or spectrum analyzer, which is connected to the signal output terminal 29.

When the output of the laser diode 9 varies, the currents flowing in the photodiodes 21 and 22 change even if the to-be-probed signal is kept at a constant state. Then, the operational amplifier 31 compares the added value of the voltages acquired via the current monitors 25 and 26 with the value of the reference voltage from the reference voltage generator 33, and feeds back a control signal which stabilizes the light from the laser diode 9. Therefore, the optical output of the laser diode 9 can be stabilized regardless of changes in the currents that flow in the photodiodes 21 and 22. This can allow the sensitivity of detection of the to-be-probed signal to be kept constant. That is, feedback control is performed on the laser diode 9 in such a way that the sum of the currents flowing in the photodiodes 21 and 22 become constant.

The voltage that is to be input to the positive input terminal of the operational amplifier 31 can be adjusted as desired by manipulating an unillustrated volume or the like provided on the reference voltage generator 33. This makes the optical output of the laser diode 9 variable so that the sensitivity of detection of a to-be-probed signal can be adjusted arbitrarily. In other words, the optical output of the laser diode 9 can be stabilized regardless of an environmental change by adjusting the amount of light from the laser diode 9 based on the variable reference voltage output from the reference voltage generator 33 in the drive-current control circuit 40. Note that arbitrary adjustment of the drive current for the laser diode 9 can also be accomplished by changing the fixed resistor 37 in the current drive circuit 35 to a variable resistor.

The connection of the gain adjuster 28 between the amplifier 27 and the probe-signal output terminal 29 can widen the detection range for a to-be-probed signal.

According to the present invention, the above object is achieved by a probe signal outputting apparatus which comprises an electrooptic probe for receiving an optical output from a light source and outputting a first optical signal and a second optical signal which are polarized in accordance with a voltage of a to-be-probed signal from an object to be measured; a first photoelectric converting element and a second photoelectric converting element, connected in series between a first bias power supply and a second bias power supply, for respectively receiving the first optical signal and the second optical signal and converting the first and second optical signals to electric signals; an output circuit for outputting an electric signal acquired at a connection node between the first photoelectric converting element and the second photoelectric converting element to a measuring circuit; an adder for adding voltage values equivalent to currents respectively flowing in the first photoelectric converting element and the second photoelectric converting element; and a drive-current control circuit for causing a current drive circuit to supply a drive current according to a change in an added output from the adder to the light source. This structure can prevent the sensitivity of detection of a to-be-probed signal from being changed due to variations in the output of the light source, loss in the optical system or the like, thereby keeping the sensitivity of detection constant, which leads to an improvement on the probing precision for a to-be-probed signal.

According to this invention, the drive current to be supplied to the light source from the current drive circuit can be adjusted through external manipulation. This structure can ensure arbitrary adjustment of the sensitivity of detection of a to-be-probed signal. Further, the current drive circuit undergoes feedback control based on a change in the added output from the adder in such a way as to make the added output constant. This structure allow the sensitivity of detection of a to-be-probed signal to be automatically adjusted.

Furthermore, the operational amplifier is connected to the reference voltage generator, which generates a reference voltage for controlling the feedback amount of a control input with respect to the current drive circuit, so that the light source can be driven by an arbitrary drive current according to a set reference voltage.

The use of a laser diode as the light source permits the light incident to the electrooptic probe to have a sufficient intensity and can ensure a sufficient sensitivity of detecting a to-be-probed signal.

What is claimed is:

1. A probe signal outputting apparatus comprising:
an electrooptic probe for receiving an optical output from a light source and outputting a first optical signal and a second optical signal which are polarized in accordance with a voltage of a to-be-probed signal from an object to be measured;
a first photoelectric converting element and a second photoelectric converting element, connected in series between a first bias power supply and a second bias power supply, for respectively receiving said first optical signal and said second optical signal and converting said first and second optical signals to electric signals;
an output circuit for outputting an electric signal acquired at a connection node between said first photoelectric converting element and said second photoelectric converting element to a measuring circuit;
an adder for adding voltage values equivalent to currents respectively flowing in said first photoelectric converting element and said second photoelectric converting element; and
a drive-current control circuit for causing a current drive circuit to supply a drive current according to a change in an added output from said adder to said light source.

2. The probe signal outputting apparatus according to claim 1, wherein said drive current to be supplied to said light source from said current drive circuit is adjustable through external manipulation.

3. The probe signal outputting apparatus according to claim 1, wherein said drive-current control circuit includes an operational amplifier for performing feedback control on said current drive circuit based on a change in said added output from said adder in such a way as to make said added output constant.

4. The probe signal outputting apparatus according to claim 1, wherein said light source is a laser diode.

5. The probe signal outputting apparatus according to claim 3, wherein said operational amplifier is connected to a reference voltage generator for generating a reference voltage for controlling a feedback amount of a control input with respect to said current drive circuit.
